(19) United States
(12) Patent Application Publication
(10) Pub. No.: US 2026/0240096 A1
(43) Pub. Date: Aug. 20, 2026

(54) IRRIGATION SYSTEM AND THE USE OF SUCH IRRIGATION SYSTEM

(71) Applicant: Daniel S. SPIRO, Scottsdale, AZ (US)

(72) Inventor: Daniel S. SPIRO, Scottsdale, AZ (US)

(21) Appl. No.: 19/413,783

(22) Filed: Dec. 9, 2025

(30) Foreign Application Priority Data
Feb. 17, 2025 (EP) 25158288.8

(51) Int. Cl. A01G 27/06; A01G 27/00; A01G 29/00

(52) U.S. Cl. CPC A01G 27/06; A01G 27/003; A01G 29/00

(57) ABSTRACT

A system, apparatus, computer program product, and method include an external pipe configured to convey irrigation fluid to an irrigation tank, and a plurality of irrigation stakes that are configured to receive the irrigation fluid from the irrigation tank and convey the irrigation fluid to soil/bedding material the vicinity of a plant root base. The irrigation system may be used in in a planter, a greenhouse or in open ground cultivation.

### CROSS-REFERENCE TO RELATED APPLICATION

The present application claims priority to European application EP25158288 filed 17 Feb. 2025, the entire contents of which is incorporated herein by reference in its entirety.

### BACKGROUND

### Technical Field

The present disclosure relates to an irrigation system and the use of such irrigation system.

### Discussion of Background

Common irrigation systems today rely on an extended piping system to deliver irrigation fluid to a plant root. The delivery system most often relies on controllers. The controllers control irrigation valves that flow pressurized irrigation fluid through the piping system to the plant's surroundings. The piping system can be above grade and/or below grade.

Several methods are geared to optimize the irrigation fluid delivery to the plant root while minimizing the usage of irrigation fluid. Among these methods are night irrigation that prevents daytime evaporation due to solar radiation, drip irrigation to enable the irrigation fluid to slowly percolate deep into the soil, deep root irrigation which is a targeted means to deliver irrigation fluid primarily for trees below trees' dripline, and controlled rationing of irrigation fluid based on season.

The means to deliver nutrients and protective plant health additives can also vary. Protective plant health additives are substances configured to combat viruses, bacteria, and/or other organisms that risk the health of the plants. The delivery methods can include over grade, below grade, and both over grade and below grade. Today's systems often includes at least one of a nutrient and a protective plant health additive delivered to the plant's root base through the irrigation fluid.

The above grade method can include spraying and/or disposing nutrients and protective plant health additives on grade with the expectation that rainwater and/or irrigation water will deliver the substances through the ground irrigation planting material to the plant root base.

The above methods can be grouped as predictive systems that anticipate plant growth cycles under conditions perfectly isolated from the surrounding environment. Regrettably, in today's outdoor environment, weather conditions have become unpredictable. As a result, farmers worldwide experience reductions in crop yields. There is hence, as recognized by the present inventor, a need for an irrigation system that is reactive to a plant's real time needs in situ. The system should be applicable, no matter if the system is intended to be used in a pot, in a greenhouse or in open ground cultivation.

### SUMMARY

According to an aspect of the present disclosure, a new irrigation system is described including an irrigation tank sized to hold a volume of irrigation fluid, the irrigation tank including an infill pipe extending upwardly relative to the irrigation tank; a base unit coupled to the infill pipe; an external fluid conveyance pipe coupled to the infill pipe via the base unit, the external fluid conveyance pipe configured to convey pressurized irrigation fluid to the irrigation tank; a valve assembly disposed within the base unit, the valve assembly including a valve and a float, wherein the float rises with a level of irrigation fluid entering the irrigation tank and, upon reaching a threshold level, actuates the valve to stop a flow of the pressurized irrigation fluid from the external fluid conveyance pipe into the irrigation tank; and a plurality of irrigation stakes fluidly coupled to the irrigation tank and configured to be embedded in soil or bedding material at a depth to correspond to a depth of a root base of a plant to be grown in the soil or bedding material, wherein the irrigation system is configured to convey the irrigation fluid from the irrigation tank to the plurality of irrigation stakes via capillary action, emitting sides of the plurality of irrigation stakes are substantially vertically aligned with the plant root base, and the plurality of irrigation stakes are configured to dispense the irrigation fluid in response to a diminishing moisture content in the soil or bedding material

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B show an elevation and a section of a mechanical base unit coupled to an infill tank of an irrigation tank respectively.

FIGS. 2A and 2B show an elevation and a section of an electrical base unit coupled to an infill tank of an irrigation tank respectively.

FIGS. 3A, 3B, and 3C show an exemplary embodiment of an irrigation tank assembly in top view, long side view, and short side view respectively.

FIGS. 4A, 4B, and 4C show an exemplary embodiment of an irrigation tank's assembly comprising two tanks in top view, long side view, and top perspective view respectively.

FIGS. 5A, 5B, and 5C show a top view, a side view, and a top perspective view of a tank's irrigation assembly inside an exemplary planter respectively.

FIGS. 6A and 6B show exemplary vertical cross sections of a planter retaining an irrigation tank's assembly.

FIGS. 7A, 7B, 7C, and 7D show a top view, a bottom view, and a side view of a direct mount to the irrigation tank stake. FIG. 7D shows a central vertical section through the stake.

FIGS. 8A, 8B, 8C, and 8D show a top view, a bottom view, and a side view of a shallow embedment piped stake. FIG. 8D shows a central vertical section through the stake.

FIGS. 9A, 9B, 9C, and 9D show a top view, a bottom view, and a side view of a deep embedment piped stake. FIG. 9D shows a central vertical section through the stake.

FIG. 10 is a block diagram of a computer-based system (processing circuitry) on which control embodiments of the present system may be implemented.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

As a brief overview, Accordingly, the present innovation employs a below grade fluid irrigation tank and a plurality of stakes. The stakes are configured to deliver irrigation fluid from the irrigation tank to a plant root base. The fluid conveyed in pipes from the irrigation tank through the stakes to the plant root base travels under capillary action.

The irrigation fluid flowing by capillary action maintains moisture levels in proximity to the plant root base in accordance with the plant's needs. The plant's needs vary throughout the plant's seasonal growth cycles, age, and the volume of moisture in the soil/bedding material existing due to other factors than the irrigation system. The plant dictates the amount of water it needs and for the duration needed to sustain its growth.

In this capacity, the fluid irrigation tank functions as a passive holding tank to support dispensing the fluid irrigation as driven by the plant. The stakes coupled directly to the irrigation tank's top surface and the stake pipes also coupled to the irrigation tank's top surface convey irrigation fluid to the plant/s root base by capillary action, elevating fluid from the tank through and above the tank to the plant/s root bases wherever they are.

The replenishment of the irrigation fluid into the irrigation tank can be accomplished manually and/or can be automated. The manual method relies on an infill pipe with a removable cap. The infill pipe with the removable cap preferably extends above the soil/bedding material top grade. There are several methods to monitor the fluid level in the irrigation tank. These methods include a mechanical float with a visual marker, and an electronic sensing and alerting device. The electronic sensing device can include at least one of an audio and/or a visual alerting device. It can also include a communication device that can transmit a remote alert via at least RF (Radio Frequency) communication when the fluid level inside the irrigation tank falls below a threshold level.

The fluid irrigation tank can be coupled to a network of fluid irrigation tanks by at least one external fluid conveying pipe that is configured to deliver irrigation fluid to the irrigation tanks from a remote source. The fluid irrigation tanks may be connected to each other via jumper pipes. Fluid conveyed through the external networked pipe flowing into the irrigation tank/s can be controlled by at least one of a mechanical valve and an electronic valve. Both the mechanical and the electronic valves' operation can be activated by a sensing device.

The mechanical valve's sensing device can be as rudimentary as a float that when the fluid irrigation level reaches a threshold level, the float activates a valve directly or indirectly, thereby stopping the flow of irrigation fluid into the tank. The valve can be unitary with the float. The electronic valve's sensing device can include at least one of a float, a laser, and an audio sonic means.

When the fluid level inside the irrigation tank falls below a threshold level, the sensing device can send a direct signal to a valve to stop the flow of fluid to the irrigation tank and/or send a signal to a processor that in turn directs a valve to stop the flow of fluid to the irrigation tank. Further, the sensing device can also trigger at least one alert type to a caretaker. The alert can include anomalies such as fluid overflowing, extreme irrigation fluid temperature, and/or an excessive rate of fluid depletion.

It is also noted that the electronic valve controlled by a processor can evacuate fluid from tanks through a fluid evacuation plug/valve when soil/bedding material may be subject to freezing. Most commonly, a communication device can be coupled to the processor that controls the electronic valve to receive and transmit such alerts.

The sensing device can be coupled to the fluid irrigation infill pipe and/or the fluid irrigation infill pipe's cap. The mechanical sensing device can activate a switch that relates a signal and/or a command to an electronic valve directly and/or indirectly via a processor. The electronic sensor relies on electrical power for operation. Electrical power can be delivered to the sensor and any other power consuming device of the fluid irrigation tank through at least one of a local power storage unit such as a battery, locally generated power via at least a photocell with a storage unit, and power conveyed from a remote source. The latter can be conveyed above and/or below grade.

The electronic devices that can be powered by at least the three aforementioned power sources can include a plurality of sensors, a valve, a processor, a power storage unit, an output device such as a speaker/microphone, and a light source, a communication device, a thermal heater, and a pump.

Another aspect of the present innovation is a method of dispensing plant nutrients and protective plant health additives. The present innovation introduces a novel concept to direct nutrients and/or protective plant health additives to the vicinity of a plant root base. This innovative concept attaches the nutrients and/or the protective plant health additive compound/s to the irrigation stake. The irrigation stake is embedded in the soil/bedding material to a depth that is substantially aligned with the depth of the specific plant material planted in its vicinity.

This method is a direct delivery method of nutrients and protective plant health additives to the vicinity of a plant root base. The additive compound/s attached to the irrigation stake can be delivered in solid, in quasi-solid, or in loose form that has a protective covering. The compounds can be configured to release its/their content in a form of time release, triggered, for example by irrigation fluid alone, or mixed with at least one other fluid.

This approach has several benefits over other, more conventional plant nutrient enrichment and measures to protect plants from ground borne viruses, bacteria, and other pests. These benefits include activating specific ingredients only when needed, avoiding clogging the irrigation system by adding compounds that can crystallize, and delivering the released compounds directly into a plant root base. In addition, this delivery method preserves costly compounds that are often wasted by rainwater runoff. Further, this method dispenses the compound/s in the proximity of the plant root base, where more conventional methods have the compound/s seep through the soil even where plant roots do not exist.

According to another aspect, an irrigation system is provided comprising an irrigation tank, an external pipe that is configured to convey irrigation fluid to the irrigation tank, a processor with memory and resident code, a power supply, a valve coupled to the base unit, a sensor, and a plurality of irrigation stakes that are configured to receive irrigation fluid from the irrigation tank and convey the irrigation fluid to the vicinity of a plant root base, wherein irrigation fluid supplied to the irrigation tank is under pressure; the valve coupled to the base unit is configured to be controlled by the processor; the irrigation fluid level in the irrigation tank is configured to be monitored by the sensor, said sensor is electrically, mechanically or electromechanically coupled to the processor; at least one local and/or remote power source is configured to power electronic device/s of the base unit including the processor circuitry (sometimes called “processor”); the sensor monitoring the irrigation fluid level in the irrigation tank is configured to signal to the processor when the irrigation fluid level inside the irrigation tank falls below a threshold level; the processor being configured to controllably open the valve to enable irrigation fluid to flow into the irrigation tank upon receipt of a signal from the sensor; and wherein irrigation fluid from the irrigation tank is configured to be conveyed by capillary action to the irrigation stakes, the irrigation stakes being configured to be directly coupled to the irrigation tank and/or embedded in the soil/bedding material in the vicinity of the irrigation tank with emitting side/s of the irrigation stakes being substantially vertically aligned with the specific plant material root base they are configured to irrigate; and wherein irrigation fluid is configured to be dispensed through the irrigation stakes at least in response to diminishing soil/bedding material moisture content caused by a plant root in the vicinity of the plant root base.

The advantages discussed above are equally and directly applicable also to the irrigation system according to this aspect.

The irrigation systems may be used in planters, in a greenhouse or in in open ground cultivation.

The utility of the present innovations can be summarized by describing several key attributes they have over other irrigation and plant health maintenance methods—
Reduced use of irrigation fluid, providing fluid to plant/s at the right volume when needed, thus curtailing irrigation fluid waste.
Directing irrigation fluid to plant/s root base, thus saving irrigation fluid that otherwise would be wasted due to percolating through the soil/bedding material away from a plant root base.
Maintaining the flow of irrigation fluid to plant over an extended time period when a water supply is not readily available.
Dispensing nutrients and plant health protection compounds in the vicinity of the plant root base by attaching the compounds to an irrigation stake.
Reducing operational tank and stake maintenance resulting from irrigation line clogging.
Introducing plant root repellent material to irrigation stakes, to protect the irrigation system from invasive root proliferation.
The placement of irrigation stakes at trees' drip line forms a robust root system that withstands wind loads.
Ability throughout plant life to add and/or relocate irrigation stakes as a plant grows.
Ability to irrigate a plurality of plant types where each type root system is in a different depth below grade.

In the following the invention with its embodiments and according to its different aspects will be discussed with reference to the drawings.

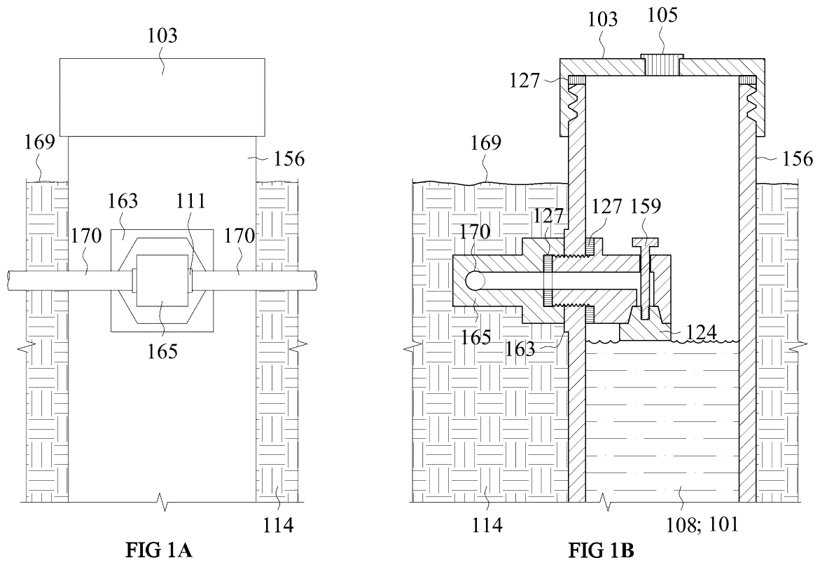

Starting with FIGS. 1A and 1i, an elevation and a section of a mechanical base unit coupled to an infill tank of an irrigation tank respectively is shown.

FIG. 1A shows a base unit 165 coupled to an infill pipe base unit retainer 163. The base unit retainer 163 is coupled to an infill pipe 156. The base unit retainer 163 can be fabricated unitarily with the infill pipe 156 or can be a coupled adaptor. An external fluid conveyance pipe 170 is shown coupled to the base unit 165 by couplers 111 from both ends. Irrigation fluid flowing through the fluid conveyance pipe 170 can be configured to provide irrigation fluid to a plurality of irrigation tanks that connect to the lower end of an infill pipe 156. The external fluid conveyance pipe 170 may accordingly extend between and interconnect several infill pipes 156.

The base unit 165 shown is coupled to the infill pipe 156. The infill pipe 156 couples at its bottom end to the irrigation tank (not shown). Its top end couples to a cap 103. At least a portion of the infill tank 156 can extend above the top of grade 169. The cap 103 can be removable.

The base unit 165 can be detachable from the infill pipe 156. A detachable base unit 165 enables quick unit replacement in the event the unit should fail. The detachable two-part assembly enables quick changeout when a different plant planted has a different irrigation regime. The base unit 165 can include a filtration device (not shown) to prevent contaminants from entering the irrigation tank (not shown). The filtration device can also be removable and can be coupled to at least one of the base unit 165 and the fluid conveyance pipe 170.

FIG. 1B shows a vertical section through the infill pipe 156 with coupled base unit 165 and a cap 103. The present embodiment shows a two-part base unit 165 comprising an external part and an internal part. The internal part comprises a float 124 integral to a valve. The float's mobility is guided by a float leader 159. The valve coupled to the float 124 is configured to open when the float 124 elevation inside the infill pipe 156 falls below a threshold level. In another embodiment the float can be inside the irrigation tank. Once the valve opens, irrigation fluid conveyed in the fluid conveyance pipe 170 can flow into the irrigation tank infill pipe 156 and further down to the irrigation tank 101 to which a lower end of the tank infill pipe 156 connects.

The two-part base unit 165 can couple to one another by at least a threaded connection with gaskets preventing fluid passage. The present figure shows an infill pipe base unit retainer 163. The base unit retainer 163 can be a surface that is configured to press against the surface of the exterior part of the base unit having a fluid tight gasket between sealing the connection. In another embodiment, an adaptor can be used coupling the base unit 165 external part to the infill pipe 156.

The placement of the base unit 165 can be configured in proximity to the infill pipe cap 103 opening. Placing the base unit in proximity to the infill pipe 156 opening enables easy base unit 165 installation and replacement. The infill pipe 156 is configured to have a minimal rise over the top of grade 169 of the soil/bedding material 114. The cap 103 covering the opening of the infill pipe 156 along with the infill pipe extension above the top of grade 169 are configured to minimally obstruct the surrounding plant material while affording easy access.

The cap 103 shown covering the infill pipe 156 opening provides access to the irrigation tank interior. While the primary means of fluid conveyance to the irrigation tank is through the base unit 165, when for any reason fluid is not conveyed through the fluid conveyance pipe 170, a caretaker can manually maintain the level of irrigation fluid in the irrigation tank by removing the cap 103 and pouring irrigation fluid through. The cap 103 can be secured to the infill pipe 156 by a thread with a gasket 127 between. Hence, infill via the cap 103 allows a secondary means of fluid conveyance to the irrigation tank.

The cap 103 can include an air breather 105 that allows air pressure to equalize, thus preventing a vacuum effect inside the irrigation tank. The air breather 105 can act as a fluid overflow egress opening when a faulty valve/float can't control the flow of irrigation fluid into the irrigation tank. It is noted that placing the infill valve 124 in proximity to the cap elevates the irrigation fluid level above the irrigation tank and closer to the top of grade. Despite the direct mounted and piped stakes' connectivity to the top of the irrigation tank, under Pascal's law, the irrigation fluid level equalizes at or in proximity to the infill valve 124. As a result, the irrigation fluid lift can be under 100 mm.

The flow rate of the irrigation fluid 108 from the irrigation tank 101 through irrigation stakes to the vicinity of a plant root base is critical for the plant's health. Too much irrigation fluid 108 causes root rot and a waste of irrigation fluid. It can also undermine the root structure making the plant susceptible to falling over when subjected to wind loads. Insufficient irrigation causes the plant to wilt. The balance between these two conditions needs to be maintained season by season throughout the life of the plant.

The mechanical valve of the irrigation tank receiving irrigation fluid under pressure from a fluid conveyance pipe 170 is configured to stop the fluid inflow once a float reaches a threshold level. The flow rate of the irrigation fluid from the irrigation tank through the irrigation stakes to the soil/bedding material in the vicinity of the plant root base can be controlled by at least one of the type of the wick used, the diameter of the wick/conduit pipe, the number of openings and size of the stake section dispensing the irrigation fluid, the number of stakes embedded in the vicinity of a plant root base, and the fluid density.

It is noted that because capillary action in part migrates fluid from a high moisture content area to a low moisture content area, it is assumed that the flow rate of the irrigation fluid slows down as moisture levels in the soil/bedding material in the vicinity of the stake increase.

In at least one other embodiment, the base unit can at least in part couple to the cap 103. Further, in at least one other embodiment (not shown) at least one nutrient and plant health substance can be let into the irrigation tank through the infill pipe 156. The length of the infill pipe 156 can vary and can be determined by at least the plant/s root base depth the irrigation tank is configured to irrigate.

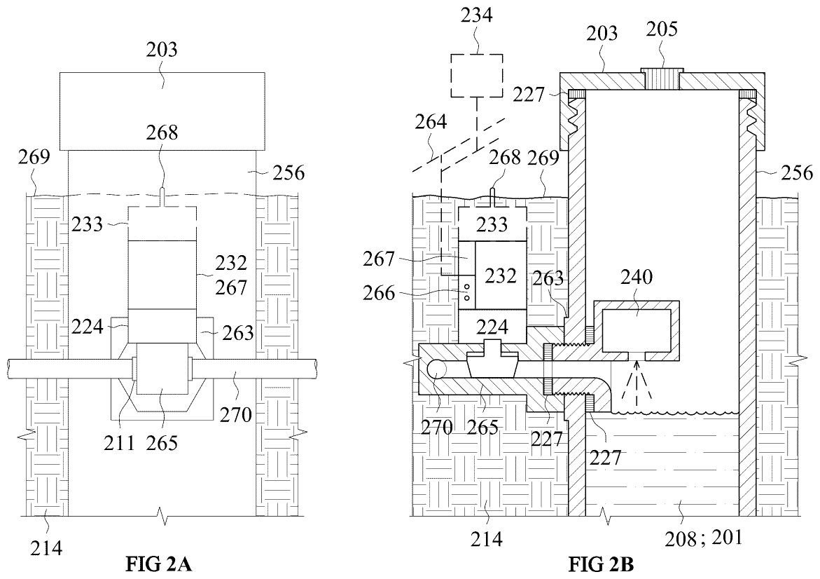

Now turning to FIGS. 2A and 2B which show an elevation and a section of an electrical base unit coupled to an infill tank of an irrigation tank respectively.

FIG. 2A shows a base unit 265 coupled to an infill pipe base unit retainer 263. The base unit retainer 263 can be fabricated unitarily with the infill pipe 256 or can be a coupled adaptor. An external fluid conveyance pipe 270 is shown coupled to the base unit 265 by couplers 211 from both ends. Irrigation fluid 208 flowing through the fluid conveyance pipe 270 can be configured to provide irrigation fluid to a plurality of irrigation tanks 201 that connect to the lower end of the infill pipe 256.

The base unit 265 shown with or without a base retainer unit 263 is configured to couple to the infill pipe 256. The infill pipe 256 at its bottom end couples to an irrigation tank 201, and at its top end couples to a detachable cap 203. At least a portion of the infill tank 256 can extend above the top of grade 269. The cap 203, with at least one air breather 205, can be fixed or detachable.

The base unit 265 shown with the present embodiment includes a valve 224, a processor 232 with resident memory and code, a resident power storage/power supply unit 267, and an optional communication device 233 with an antenna 268. The communication device 233 is shown in dashed lines. It is noted that the present base unit 265 is configured to operate by electrical power. The electrical power can be delivered from a remote source and/or can be generated locally by, for example, a photovoltaic panel.

The base unit 265 can be detachable from the infill pipe 256. The detachable base unit 265 enables quick unit replacement when the unit fails. A detachable base unit 265 also enables quick changeout to a different style base unit 265. Such a changeout may occur when a different plant planted has a different irrigation regime. The base unit 265 can include a filtration device (not shown) to prevent contaminants from entering the irrigation tank (not shown). The filtration device can also be removable and coupled to at least one of the base unit 265 and the fluid conveyance pipe 270.

FIG. 2B shows a vertical section through infill pipe 256 with a coupled base unit 265 and a cap 203. The present embodiment shows a two-part base unit 265 comprising an external part and an internal part. The internal part comprises a sensor 240 that is configured to monitor the irrigation fluid level in the irrigation tank 201 below and directly or indirectly open a valve 224 when the sensed irrigation fluid level inside the tank falls below a threshold level.

The sensor 240 can be fully electronic and/or electromechanical. The electromechanical sensor can employ, for example, a float (not shown) that is connected to an electronic switch. The electronic switch can be configured to directly actuate the valve 224, or transmit a signal to a processor 232 that in turn opens the valve 224. The electronic sensor can be operated employing at least one of, Doppler effect and laser depth sensing principle.

The external part of the base unit 265 can be configured to include at least one of a processor 232, a power storage unit/power supply 267, a power entry port 266 configured to receive electrical conductors, and a valve 224. The present figure also shows an optional communication device 233 with an antenna 268 extending above top of grade 269.

The communication device 233 can be configured to establish at least RF (Radio Frequency) communication between the base unit processor 232 and at least one remote client.

The processor 232 is coupled to a sensor 240. The processor 232 is configured to control the operation of the valve 224. When the fluid level inside the irrigation tank falls below a threshold level, the processor directs the valve 224 to open, letting irrigation fluid from the exterior fluid conveyance pipe enter the irrigation tank 201. When the fluid level reaches the threshold level, the processor 232 then directs the valve 224 to close, stopping the inflow of the irrigation fluid.

The present figure also shows two power sources. The first is a remote power source 264 that can be conveyed below or above the soil/bedding material 214 top level grade 269. The second power source can be locally generated power that can include at least one of a photovoltaic panel 234 and a wind turbine (not shown).

The processor's 232 code can include a plurality of sub-programs. At least one of the programs can include self-learning algorithms that can be configured to learn the specific environmental conditions surrounding an irrigation tank, process the data and apply the learned knowledge to improve on the system's utility. The learned knowledge applies both to the irrigation system operational utility and the data collected about the plant/s irrigated by the irrigation tank.

In at least one embodiment, the code employing AI logic can reach out to external clients to receive information and/or to seek advice concerning anomalies experienced with a plant and/or the environment where the plant is planted. The processor 232 when coupled to a communication device 233 can also receive and/or transmit data. For example, a central monitoring station can communicate via a central controller or directly to an array of irrigation tanks that ground freeze is expected in proximity to the irrigation tank.

The processor 232 of each of the irrigation tanks can then direct a flush valve (not shown) in the irrigation tank to evacuate the tank's irrigation fluid.

In the same or another embodiment, when the irrigation fluid infill valve 224 fails, the processor 232 acting on input from the sensor 240, via its communication device can communicate an alert to a caretaker that the infill valve has failed. In yet the same or a different embodiment, a moisture probe (not shown) can be embedded in the soil/bedding material. When the probe communicates to the processor 232 that the soil/bedding material is over saturated, the processor 232 can stop the infill valve 224 from letting fluid into the tank.

The two-part base unit 265 can couple to one another by at least a threaded connection with gaskets that prevent fluid leakage. The present figure shows an infill pipe base unit retainer 263. The base unit retainer 263 can be a surface configured to press against the surface of the exterior part of the base unit 265 having a fluid tight gasket between sealing the connection.

The base unit retainer 263 can be fabricated unilaterally with an infill pipe 256. In a different embodiment an adaptor can be used for coupling the base unit 265 to the infill pipe 256. The placement of base unit 265 can be in proximity to the infill pipe cap 205 opening. Placing the base unit 265 in proximity to the infill pipe 256 opening enables easy base unit 265 installation and replacement.

The infill pipe 256 is configured to have a minimal rise over the top of grade 269 of the soil/bedding material 214. The cap 203 covering the opening of the infill pipe 256 along with the infill pipe 256 extension above the top of grade 269 are configured to minimally obstruct the surrounding plant material while affording easy access.

The cap 203 shown covering the infill pipe 256 opening provides access to the irrigation tank interior. While the primary means of fluid conveyance to the irrigation tank is through the base unit 265, when for any reason fluid is not conveyed through the fluid conveyance pipe 270, a caretaker can manually maintain the irrigation fluid in the irrigation tank by removing the cap 203 and pouring irrigation fluid through. Hence, infill via the cap 203 allows a secondary means of fluid conveyance to the irrigation tank.

The cap 203 can be secured to the infill pipe 256 by a thread with a gasket 227 between. The cap 203 can include an air breather 205 that allows air pressure to equalize, thus preventing a vacuum effect inside the irrigation tank. The air breather 205 can act as a fluid overflow egress opening when a faulty infill valve 224 fails to control the flow of irrigation fluid into the irrigation tank.

In at least one other embodiment (not shown), the base unit can at least in part couple to the cap 203. Further, in at least one other embodiment (not shown) at least one nutrient and a plant health substance can be let into the irrigation tank 201 through the infill pipe 256. The length of the infill pipe 256 can vary and can be determined by at least the plant/s root base depth the irrigation tank is configured to irrigate.

It is noted that placing the infill valve 224 in proximity to the cap elevates the irrigation fluid level above the irrigation tank and closer to the top of grade. Despite the direct mounted and piped stakes' connectivity to the top of the irrigation tank, under Pascal's law, the irrigation fluid level equalizes at or in proximity to the infill valve 224. As a result, the irrigation fluid lift can be under 100 mm.

The flow rate of the irrigation fluid 208 from the irrigation tank 201 through the irrigation stakes to the vicinity of a plant root base is critical for the plant's health. Too much irrigation fluid 208 causes root rot and a waste of irrigation fluid. It also can undermine the root structure, making the plant susceptible to falling over when subjected to wind loads. Insufficient irrigation causes the plant to wilt. The balance between these two conditions needs to be maintained season by season throughout the life of the plant.

The flow rate of the under-pressure irrigation fluid 208 entering the irrigation tank with the electrical valve 224 can be controlled. The control can be local or remote. The locally controlled system can comprise a moisture probe that is embedded in the vicinity of the irrigation tank and is communicatively coupled to the irrigation tank processor 232. When the moisture level reaches a threshold level, the moisture probe (not shown) sends a signal to the processor 232 and the processor 232 directs the valve 224 to stop and/or limits the flow of the irrigation fluid 208 entering the irrigation tank until soil/bedding material 214 moisture conditions sensed let the processor 232 know that moisture levels in the soil/bedding material 214 have fallen below a second minimum level. Then the processor 232 directs the valve 224 to open, letting replenished irrigation fluid 208 enter the irrigation tank.

The flow rate of the irrigation fluid 208 from the irrigation tank through the irrigation stakes (not shown) to the soil/bedding material 214 in the vicinity of the plant root base can be controlled by at least one of the type of the wick used, the diameter of the wick/conduit pipe, the number of openings and size of the stake section dispensing the irrigation fluid, the number of stakes embedded in the vicinity of a plant root base, and the fluid density.

In a different embodiment, a master controller (not shown) can control a plurality of irrigation tanks' fluid inlet valves 224. The master controller processor can be coupled to a master moisture probe (not shown) and a communication device (not shown) that can communicatively couple to the communication devices coupled to the irrigation tanks. The master controller code can be driven by AI algorithms including self-learning algorithms that are trained to configure the irrigation flow needs based on at least local soil/bedding material 214 composition, time of day, time of year, plant age, weather conditions, and historical data gathered and compiled. The master controller can receive and communicate inputs received from a remote location. Further, while the master controller is generally configured to control a plurality of irrigation tanks, it can also control individual tanks.

In commercial applications, a master controller can monitor the plant's health condition by employing a resident UAV (not shown). The master controller can direct the UAV (Unmanned Aerial Vehicle) to fly over a designated area and gather images that correlate a plant with a digital map giving each plant an address. The images captured can be analysed by the processor code triggering a follow-up action. The action can include directing a valve of at least one irrigation tank to supply fluid to the plant. The images analysed can also trigger the use of nutrient and/or plant health control to combat or prevent diseases.

It is noted that because capillary action in part migrates fluid from high moisture content area to a low moisture content area it is assumed that the flow rate of the irrigation fluid slows down as moisture levels in the soil/bedding material in the vicinity of the stake increases.

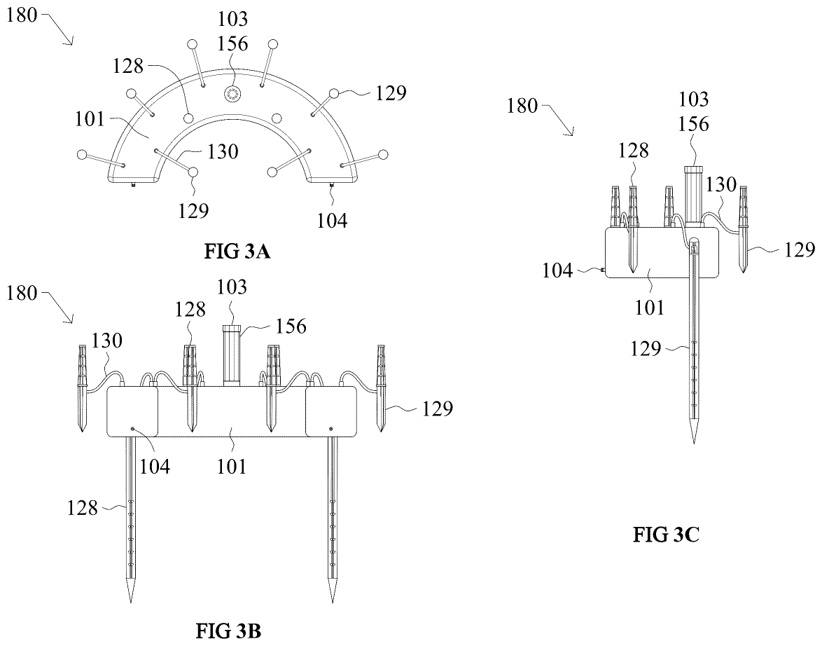

FIGS. 3A, 3B, and 3C show an exemplary embodiment of an irrigation tank assembly in top view, long side view, and short side view respectively.

FIG. 3A shows a top view of an irrigation tank assembly 180 comprising a crescent shaped irrigation tank 101 coupled to a plurality of stakes 128 and an infill pipe 156 with a cap 103 on top. The crescent form irrigation tank is primarily configured to be placed next to a trunk of a bush or a tree. A complimentary crescent shaped irrigation tank 101 can be placed on the opposite side to the tank, thus doubling the fluid storage capacity of the tank 101. Jumper pipes (not shown) coupled to nipples 104 at the ends of the crescent can connect between the two tanks 101. The irrigation tank assembly 180 can be provided with a system of the types that have been discussed above with reference to FIGS. 1A and 1B and 2A and 2B, i.e. either with a mechanical base unit system or an electrical base unit system. The irrigation tank assembly may be applied in a planter, a greenhouse or in open ground cultivation.

Two types of stakes shown include direct mounted stakes 128 and piped stakes 129. Piped stakes 129 couple to a top surface of the irrigation tank 101. Piped stakes 129 are embedded in the soil/bedding material away from the irrigation tank with a pipe 130 extending from the stake 129 to a top surface of the irrigation tank 101. It is noted that the irrigation fluid conveyed from both the direct mounted 128 and the piped stakes 129 can travel upwardly exiting the irrigation surface through openings in the irrigation tank top surface.

FIG. 3B shows a long elevation view of an irrigation tank assembly 180 comprising an irrigation tank 101, a plurality of short piped irrigation stakes 129, a plurality of deep piped irrigation stakes 129, a plurality of direct mounted irrigation stakes 128, pipes 130 configured to convey fluid to the piped irrigation stakes 129, an infill pipe 156 with a cap 103 on top, and nipples 104 configured to couple to jumper pipes (not shown).

FIG. 3C shows a long elevation view of an irrigation tank assembly 180 comprising an irrigation tank 101, a plurality of short piped irrigation stakes 129, a plurality of deep piped irrigation stakes 129, a plurality of direct mounted irrigation stakes 128, pipes 130 configured to convey fluid to the piped irrigation stakes 129, an infill pipe 156 with a cap 103 on top, and nipples 104 configured to couple to jumper pipes (not shown).

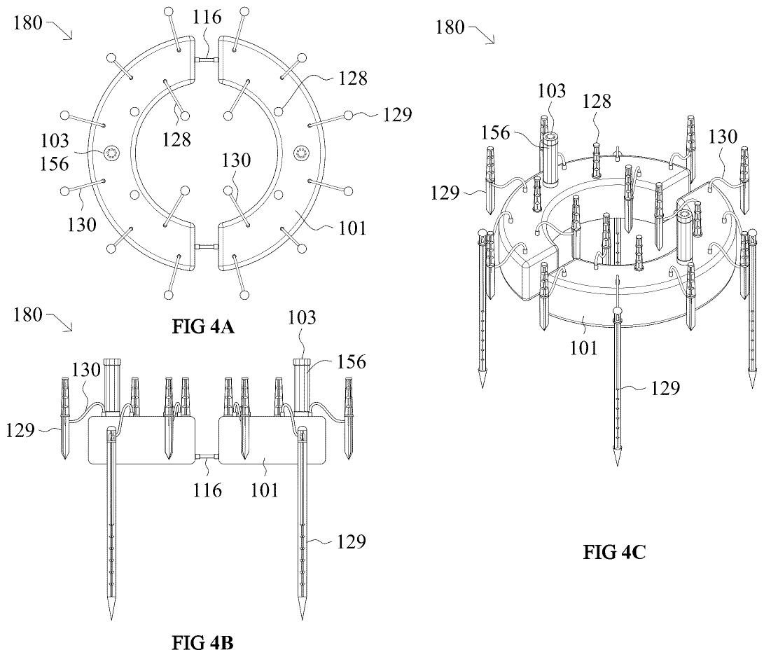

FIGS. 4A, 4B, and 4C show an exemplary embodiment of an irrigation tank assembly comprising two tanks in top view, long side view, and top perspective view respectively.

FIG. 4A shows a top view of an irrigation tank assembly 180 comprising two crescent shaped irrigation tanks 101 coupled to a plurality of direct mounted stakes 128; and piped stakes 129 and an infill pipe 156 with a cap 103 on top. The crescent form irrigation tank can be configured to be placed around a trunk of a bush or a tree. Jumper pipes 116 can connect between the two tanks 101. The irrigation tank assembly 180 can be provided with a system of the types that have been discussed above with reference to FIGS. 1A and 1B and 2A and 2B, i.e. either with a mechanical base unit system or an electrical base unit system. The irrigation tank assembly may be applied in a planter, a greenhouse or in open ground cultivation.

The two types of stakes shown include direct mounted stakes 128 and piped stakes 129. Direct mounted stakes 128 couple to a top surface of the irrigation tank 101. Piped stakes are embedded in the soil/bedding material away from the irrigation tank with a pipe extending from the stake 129 to a top surface of the irrigation tank 101. The two tanks' assemblies can have its own infill pipe 156 that can enable irrigation access to the plant from opposite sides while the irrigation fluid can flow all around to the root base of the bush/tree.

It is noted that the irrigation fluid conveyed from both the direct mounted and the piped stake 128, 129 can travel upwardly, exiting the irrigation surface through openings in the irrigation tank top surface. It is further noted that the shape of the irrigation tank can vary, and the tank can be embedded in both indoor and outdoor environments inside planters' bedding material or outdoor environment soil.

FIG. 4B shows a long elevation view of an irrigation tank assembly 180 comprising two irrigation tanks 101, a plurality of short piped irrigation stakes 129, a plurality of deep piped irrigation stakes 129, a plurality of direct mounted irrigation stakes 128, pipes 130 configured to convey fluid to the piped irrigation stakes, infill pipes 156 with a caps 103 on top, and a jumper pipe 116.

FIG. 4C shows a top perspective view of an irrigation tank assembly 180 comprising an irrigation tank 101, a plurality of short piped irrigation stakes 129, a plurality of deep piped irrigation stakes 129, a plurality of direct mounted irrigation stakes 128, pipes 130 configured to convey fluid to the piped irrigation stakes, and infill pipes 156 with caps 103.

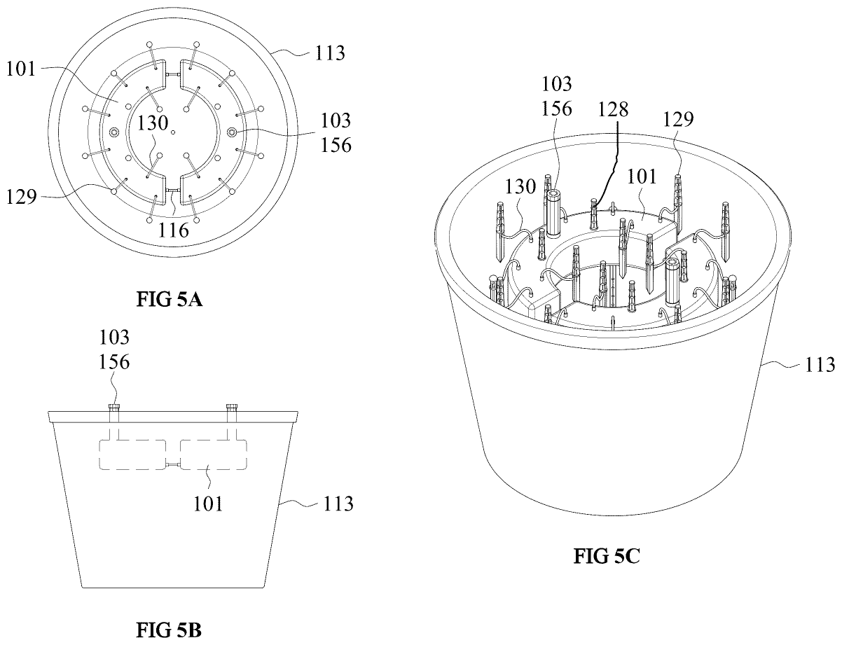

FIGS. 5A, 5B, and 5C show a top view, a side view, and a top perspective view of a tank irrigation assembly inside an exemplary planter respectively.

FIG. 5A shows a top view of an irrigation tanks assembly positioned inside a planter 113. The irrigation tank assembly 180 can be provided with a system of the types that have been discussed above with reference to FIGS. 1A and 1B and 2A and 2B, i.e. either with a mechanical base unit system or an electrical base unit system. The irrigation tank assembly may be applied in a planter, a greenhouse or in open ground cultivation.

The assembly form follows the form of the round planter 113 leaving a gap between the outer walls of the irrigation tanks 101 and the inner walls of the planter 113. The gap formed enables planting flowers and bushes at the inner perimeter of the planter 113 with piped irrigation stakes 129. The pipes 130 extend from the irrigation tanks 101 to the stakes 129 wherein the thus piped irrigation stakes 129 are embedded in the bedding material (not shown) in proximity to the plant's root base (not shown). The elements shown include infill pipes 156 with caps 103 on top and jumper pipes connecting the irrigation fluid flow between the two irrigation tanks 101.

FIG. 5B shows a side view of planter 113 with an approximate location of the irrigation tank 101 assembly embedment inside the planter 113 (in dashed lines). Above the top surface of the planter 113, two infill pipes 156 with caps 103 are shown.

FIG. 5C shows a top view perspective of an irrigation tank assembly comprising two tanks 101 inside a round planter 113. The elements shown include piped stakes 129, direct mounted to the tanks' stakes 128, pipes 130 extending from the irrigation tanks 101 to the piped stakes 129, and infill pipes 156 with caps 103 on top.

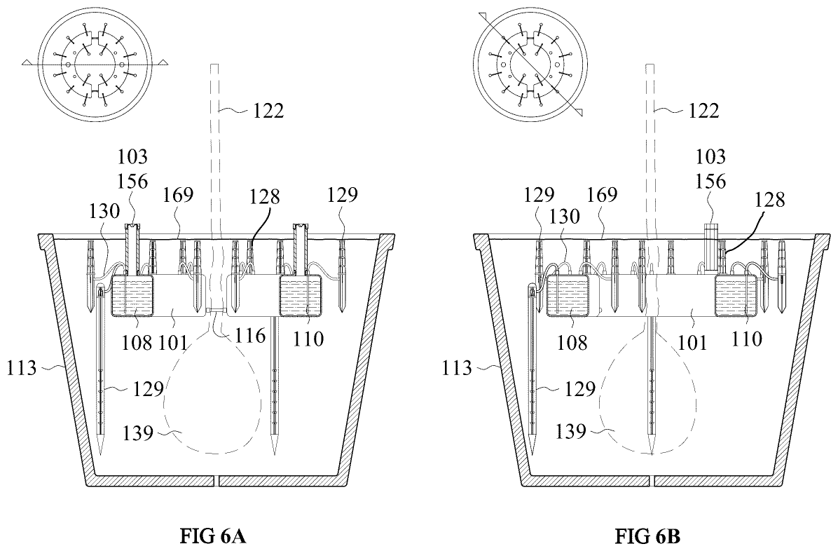

FIGS. 6A and 6B show exemplary vertical cross sections of a planter retaining an irrigation tank assembly. The irrigation tank assembly can be provided with a system of the type that has been discussed above with reference to FIGS. 1A and 1B and 2A and 2B, i.e. either with a mechanical base unit system or an electrical base unit system.

FIG. 6A shows a vertical cross section of planter 113 with an irrigation tank assembly 180 embedded inside. A reference plan above the figure shows that the section is taken across the infill pipes 156 of the two coupled irrigation tanks 101. The two tanks 101 shown are coupled by a jumper pipe 116 configured to enable flow of irrigation fluid between the tanks 101.

At the centre of the tank 101 in dashed lines a tree root base 139 is shown with a tree trunk 122 shown extending to the above. Deep root piped irrigation stakes shown at the sides of the tree's root base 139 are configured to convey irrigation fluid to a depth compatible with the tree's root system adapted to extract moisture from the bedding material.

The figure also shows irrigation fluid 108 inside the irrigation tank 101 and a plurality of wicks 110 immersed in the irrigation fluid 108. Irrigation fluid 108 is configured to irrigate plant root bases above, in between, and below the irrigation tanks 101 by capillary action. A wick 110 is shown immersed in irrigation fluid 108 inside the irrigation tank 101. The wick 110 is configured to convey irrigation fluid 108 by capillary action through opening/s in the top of the irrigation tanks 101 to coupled direct mounted irrigation stakes 128 and piped stakes 129. The embedded stakes 128; 129 dispense the irrigation fluid 108 in the proximity of at least one plant root base 139.

It is noted that the present irrigation system reacts in response to the plant's irrigation fluid's 108 needs. As a plant extracts irrigation fluid from the soil/bedding material, the approximate fluid volume is dispensed by an irrigation stake in the vicinity of the plant root base.

FIG. 6B shows a vertical cross section of planter 113 with an irrigation tank assembly 180 embedded inside. The present figure's section is shown at 45° to FIG. 6A as indicated in the reference plan above the figure. The elements shown include a tree root base 139 with a tree trunk 122 extending to the above (in dashed line), an irrigation tank 101 with irrigation fluid 108 inside, an infill pipe 156 with a cap 103 above, and a plurality of irrigation stakes comprising direct mounted stakes 128 to the irrigation tank 101 and piped stakes 129 that employ pipes 130 to convey the irrigation fluid 108 from the tanks' 101 interior to the proximity of at least one root base 139. The piped stakes 129 can be delivered in several sizes and embedment depths.

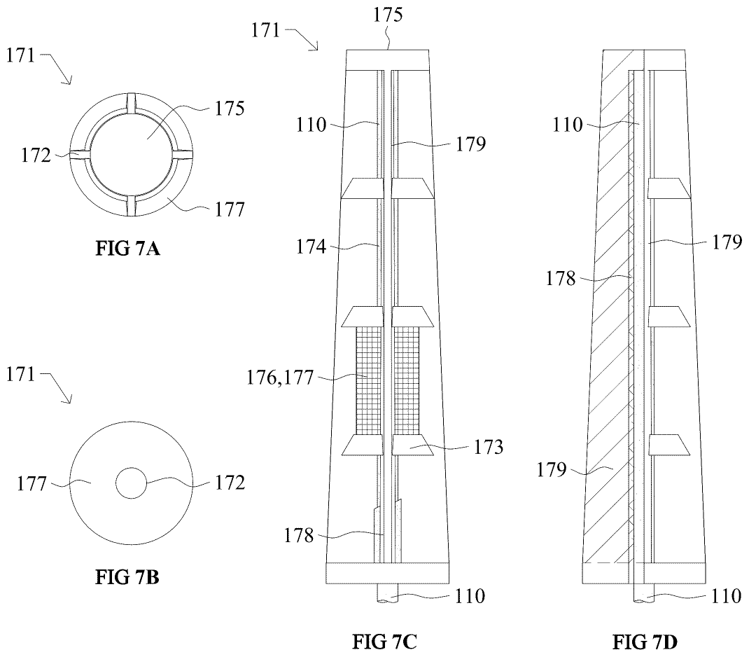

FIGS. 7A, 7B, 7C, and 7D show a top view, a bottom view, and a side view of a direct mount to the irrigation tank stake. FIG. 7D shows a central vertical section through the stake. The disclosed stake is of the same overall type as the direct mount stake 128 described above and is applicable in any of the systems described above.

FIG. 7A shows a top view of a direct mount irrigation stake 171. The direct mount irrigation stake is configured to couple to the top surface of an irrigation tank (omitted). The top surface of the direct mount irrigation stake elevation can be configured to be at or just below the soil/bedding material top of grade. Other elements shown include a direct mount stake rib 179 and a direct mount stake base 177.

FIG. 7B shows a bottom view of a direct mount irrigation stake 171. The direct mount irrigation stake is configured to couple to the top surface of an irrigation tank (omitted). The direct mount irrigation stake base 177 can comprise a planar surface with a central direct mount stake base opening 172. The opening 172 can be configured to couple to a reciprocating threaded or unthreaded nipple at the top of the irrigation tank.

In an alternate embodiment, the direct mount irrigation base 177 can have a threaded or unthreaded nipple that extends downward from the base and is configured to couple to a reciprocating opening in the top surface of the irrigation tank. The nipple can be unitary with the direct mount irrigation stake, or detached and can function as a coupler. The direct mount irrigation stake opening 172 enables the irrigation wick 110 entry into the wick channel above.

FIG. 7C shows a side view of a direct mount irrigation stake 171. The direct mount irrigation stake is configured to couple to the top surface of an irrigation tank (omitted). The height of the direct mount stake 171 is contingent on at least one of the embedment of the irrigation tank in the soil/bedding material and the effective placement of the fluid dispensing wick in relation to the depth of the plant root base. Under sea level atmospheric conditions, capillary action irrigation fluid rise is limited. For this reason, when any irrigation stake lifts fluid from an irrigation tank the limit recommended should not exceed 100 mm above the tank's fluid level at approximately sea level atmospheric conditions.

The direct mount irrigation stake figure shows a base 177, a stake rib stiffener, a wick channel 174, a wick 110, a wick rib, and a top section 175. At the bottom above the direct mount stake base 177 a section of an alternate wick covering is shown. This covering, configured to be anti-root barrier, can be at least one membrane of copper oxide with perforated openings for dispensing irrigation fluid and capillary fabric that is tightly knit. The first method is configured to repel plant roots and the second method aims to create difficulty for plant roots to penetrate the fabric and interfere with the wick's ability to convey the irrigation fluid. In at least one embodiment, the capillary fabric can be the wick.

The direct mount irrigation stake 171 can convey nutrient and anti-virus-bacteria-pest substance/s to a plant. The present figure shows at least one anti-virus, anti-bacteria, anti-pest substance/s 176 coupled. The substance/s can be delivered and attached to the stake in hardened, semi-hardened, and loose form with covering. These substances can be configured to release their content/s over time, wherein at least in one embodiment the release is activated by contact with the irrigation fluid.

In a different embodiment the release of at least one substance can be triggered by adding at least one additional material to the irrigation fluid. It is noted that the present method of preserving plant health while providing needed nutrients maintains the present irrigation fluid conveyance system free from obstruction likely to be caused by said substances.

FIG. 7D shows a partial vertical cross section through a direct mount irrigation stake 171. The elements shown include a stake rib 179, an optional anti-root barrier 178, and a wick 110.

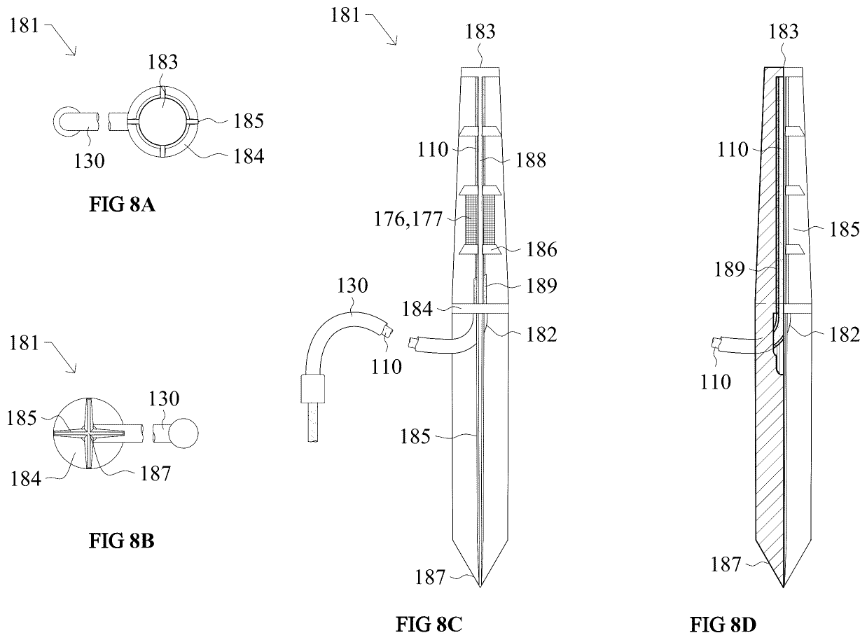

FIGS. 8A, 8B, 8C, and 8D show a top view, a bottom view, and a side view of a shallow embedment piped stake. FIG. 8D shows a central vertical section through the stake. The disclosed stake is of the same overall type as the piped stake 129 described above and is applicable in any of the systems described above.

FIG. 8A shows a top view of a short or medium (S/M) length piped irrigation stake 181. The S/M piped irrigation stake 181 is configured to be embedded in soil/bedding material in the vicinity of the irrigation tank. The S/M piped irrigation stake 181 is configured to deliver irrigation fluid through a pipe with a wick to plants that have a relatively shallow root base.

A pipe 130 shown conveys the irrigation fluid upwardly toward the S/M piped irrigation stake top 183. A portion of this stake and more specifically the portion extending above the location where the pipe enters can be the same or similar in design to the previously direct mount irrigation stake. Other elements shown include the S/M stake base 184, and the S/M stake rib 185. The S/M piped stake 181 is configured to be driven into the soil/bedding material by force applies on its top surface 183.

FIG. 8B shows a bottom view of an S/M piped irrigation stake 181. The S/M piped irrigation stake elements shown include a stake pipe 130 conveying irrigation fluid to the S/M piped stake 181, the stake's vertical ribs 185 converging into a tip 187 at the bottom end, and the stake's base 184.

FIG. 8C shows a side view of an S/M piped irrigation stake 181. The S/M piped irrigation stake 181 shown comprises two sections. The first section extends from the S/M stake base 184 to the S/M top 183. The height of the S/M stake 181 first section is contingent on at least one of the embedment of the irrigation tank in the soil/bedding material and the effective placement of the fluid dispensing wick in relation to the depth of the plant root base. The second section extends down from the S/M piped irrigation stake base 184.

At sea level atmospheric conditions, capillary action for lifting irrigation fluid is limited. For this reason, it is recommended to limit the lift height to less than 100 mm above an irrigation tank fluid level. However, coupled with Pascal's law as it applies to the relative height of the infill valve in the infill pipe and the stakes' irrigation pipes 130, the lift height of the irrigation fluid by capillary action beyond the irrigation fluid top level is well below the recommended limit.

The S/M piped irrigation stake 181 figure shows a base 184, a stake rib stiffener 186, a wick channel 184, a wick 110, a wick rib 185, and a top section 183. Above the S/M stake base 184 a section partial covering over the wick 110 is shown. This covering, configured to be anti-root barrier 189, can be at least one membrane of copper oxide with a perforated opening for dispensing irrigation fluid and capillary fabric that is tightly knit. The first method is configured to repel plant roots and the second method aims to create difficulty for plant roots to penetrate the fabric and interfere with the wick's ability to convey the irrigation fluid. In at least one embodiment, the capillary fabric can be the wick.

It is noted that while the present figure shows an irrigation pipe that is configured to extend from the stake to the irrigation tank, in at least one different embodiment, a quick connect fitting can be configured to connect a pipe 130 to a stake without disrupting the capillary fluid conveyance system from the irrigation tank through and out of the irrigation stake (not shown). This approach can enable a user to order the correct type of stake along with the best nominal irrigation stake pipe that includes a compatible wick.

The S/M piped irrigation stake 181 can convey nutrient and anti-virus-bacteria-pest substance/s to plants. The present figure shows at least one anti-virus, anti-bacteria, anti-pest substance/s 179 coupled. The substance/s can be delivered and attached to the stake in hardened, semi-hardened, and loose form with covering.

These substances can be configured to release their content/s over time wherein at least in one embodiment the release is activated by contact with the irrigation fluid. In a different embodiment the release of at least one substance can be triggered by adding at least one additional material to the irrigation fluid.

It is noted that the present method of preserving plant health while providing needed nutrients maintains the present irrigation fluid conveyance system free from obstruction likely to be caused by said substances.

FIG. 8D shows a partial vertical cross section through an S/M piped irrigation stake 181. The elements shown include an S/M piped staked rib 185, an S/M piped stake pipe entry 182, an optional anti-root barrier 189, an S/M piped stake top surface 183, and a wick 110.

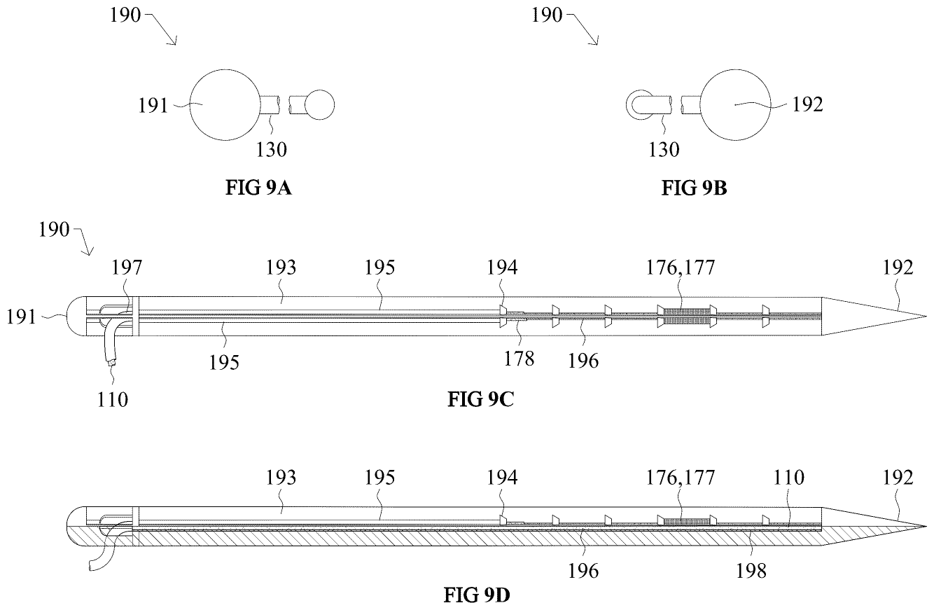

FIGS. 9A, 9B, 9C, and 9D show a top view, a bottom view, and a side view of a deep embedment piped stake. FIG. 9D shows a central vertical section through the stake. The disclosed stake is of the same overall type as the piped stake 129 described above and is applicable in any of the systems described above.

FIG. 9A shows a top view of a long (L) piped irrigation stake 190. The L piped irrigation stake 190 is configured to be embedded in soil/bedding material in the vicinity of the irrigation tank. The L piped irrigation stake 190 is configured to deliver irrigation fluid through a pipe with a wick to plants that have a deep root base. The pipe 130 shown is configured to convey the irrigation fluid upwardly toward the L piped stake top 183. The L piped irrigation stake 190 is configured to be driven into the soil/bedding material by force applied on its top surface 191.

FIG. 9B shows a bottom view of a L piped irrigation stake 190. The L piped irrigation stake elements shown include a stake pipe 130 conveying irrigation fluid to the L piped irrigation stake 190, and the stake's tip 192.

FIG. 9C shows a side view of an L piped irrigation stake 190. The L piped irrigation stake 190 shown comprises two sections. The first section extends from the vicinity of the top of L piped irrigation 191 to at least below the bottom surface of the irrigation tank (not shown). This section can include a L piped irrigation leader 195. The leader 195 does not have any opening to dispense irrigation fluid and acts as a conduit for the wick to extend to the below.

The second section is the portion of the stake that delivers the irrigation fluid to the plant root base. The second section with a tipped end 192 at the bottom of the stake 190 is responsible for driving the stake 190 to its embedment depth. It is noted that, unlike the other stakes that flow irrigation fluid primarily from below to the above, the L piped irrigation stake flows the irrigation fluid from the above to the below.

At sea level atmospheric conditions, capillary action for lifting irrigation fluid is limited. For this reason, it is recommended to limit the lift height to less than 100 mm above an irrigation tank fluid level. However, coupled with Pascal's law as it applies to the relative height of the infill valve in the infill pipe and the stakes irrigation pipes 130, the lift height of the irrigation fluid by capillary action beyond the irrigation fluid top level is well below the recommended limit.

The L piped irrigation stake 190 figure shows a pipe 130 with a wick 110, a stake top surface 191, a stake pipe opening 197, a stake rib 193, a stake leader 195, a rib stiffener 194, a stake wick channel 196, a stake tip 192 a base 184, a stake rib stiffener 186, a wick channel 184, a wick 110, a wick rib 185, and a partial covering over the wick below the bottom end of the stake leader 195. This covering, configured to be anti-root barrier 198, can be at least one membrane of copper oxide with a perforated opening for dispensing irrigation fluid and capillary fabric that is tightly knit. The first method is configured to repel plant roots and the second method aims to create difficulty for plant roots to penetrate the fabric and interfere with the wick's ability to convey the irrigation fluid. In at least one embodiment, the capillary fabric can be the wick.

It is noted that while the present figure shows an irrigation pipe that is configured to extend from the stake to the irrigation tank, in at least one different embodiment, a quick connect fitting can be configured to connect a pipe 130 to a stake without disrupting the capillary fluid conveyance system from the irrigation tank through and out of the irrigation stake (not shown). This approach can enable a user to order the correct type of stake along with the best nominal irrigation stake pipe that includes a compatible wick.

The L piped irrigation stake 190 can convey nutrient and anti-virus-bacteria-pest substance/s to plants. The present figure shows at least one anti-virus, anti-bacteria, anti-pest substance/s 199 coupled. The substance/s 199 can be delivered and attached to the stake in hardened, semi-hardened, and loose form with covering.

These substances can be configured to release their content/s over time wherein at least in one embodiment the release is activated by contact with the irrigation fluid. In a different embodiment the release of at least one substance can be triggered by adding at least one additional material to the irrigation fluid. It is noted that the present method of preserving plant health while providing needed nutrients maintains the present irrigation fluid conveyance system free from obstruction likely to be caused by said substances.

FIG. 9D shows a partial vertical cross section through an L piped irrigation stake 190. The elements shown include an L piped stake leader 195, an L piped staked rib 193, an L piped stake stiffener 194, nutrient 176, anti-virus, bacteria, pest substance/s 177, an optional anti-root barrier 198, an L stake wick channel 196, and a wick 110.

The irrigation systems with the irrigation stakes described above may be used in planters, in a greenhouse or in in open ground cultivation. Although the irrigation tank has been described and illustrated as having a crescent shape, it is to be understood that the irrigation tank may have any geometry. The skilled person realizes that the geometry is best adapted to the intended use and position of the irrigation tank. As a non-limiting example, in the event of a rectangular cultivation bed, no matter if it is a planter, in a greenhouse or open ground cultivation, it may be most space efficient and most practical to provide a rectangular irrigation tank, whereas if the system is intended for a tree, one or more crest shaped may be better suitable to encircle the trunk. Further, the irrigation system is applicable in a planter, in a greenhouse or in open ground cultivation. Hence, the irrigation is applicable both for indoor and outdoor cultivation. The type of irrigation stakes, and the number of irrigation stakes is adapted to the intended application. Further, as given above, the replenishment of the irrigation fluid into the irrigation tank can be accomplished manually and/or be automated

The invention may in one aspect be defined as follows:

Item 1: An irrigation system comprising an irrigation tank, an external pipe that is configured to convey irrigation fluid to the irrigation tank, a processor with memory and resident code, a power supply, a valve coupled to the base unit, a sensor, and a plurality of irrigation stakes that are configured to receive irrigation fluid from the irrigation tank and convey the irrigation fluid to the vicinity of a plant root base, wherein
irrigation fluid supplied to the irrigation tank is under pressure;
the valve coupled to the base unit is configured to be controlled by the processor; the irrigation fluid level in the irrigation tank is configured to be monitored by the
sensor, said sensor is electrically, mechanically or electromechanically coupled to the processor;
at least one local and/or remote power source is configured to power consuming device/s of the base unit including the processor;
the sensor monitoring the irrigation fluid level in the irrigation tank is configured to signal to the processor when the irrigation fluid level inside the irrigation tank falls below a threshold level;
the processor being configured to controllably open the valve to enable irrigation fluid to flow into the irrigation tank upon receipt of a signal from the sensor; and wherein
irrigation fluid from the irrigation tank is configured to be conveyed by capillary action to the irrigation stakes, the irrigation stakes being configured to be directly coupled to the irrigation tank and/or embedded in the soil/bedding material in the vicinity of the irrigation tank with emitting side/s of the irrigation stakes being substantially vertically aligned with the specific plant material root base they are configured to irrigate; and
wherein irrigation fluid is configured to be dispensed through the irrigation stakes at least in response to diminishing soil/bedding material moisture content caused by a plant root in the vicinity of the plant root base.

Item 2: The irrigation system of Item 1, further comprising at least one of a communication module and a power generating device being configured to be coupled to the base unit.

Item 3: The irrigation system of Item 1, wherein resident processor code is configured to monitor irrigation tank fluid consumption and communicate predictive consumption anomalies.

Item 4: The irrigation system of Item 1, wherein at least one power consuming device coupled to the base unit power is a photovoltaic panel.

Item 5: The irrigation system of Item 1, wherein a coupled communication device is configured to transmit signal from or from and to processor of the irrigation tank base unit.

Item 6: The irrigation system of Item 1, wherein a signal from the base unit processor is configured to trigger irrigation tank fluid to flash through a discharge valve.

Item 7: The irrigation system of Item 1, wherein power from a remote power source is configured to be delivered to the irrigation tank by means of at least one of below and above conductors.

Item 8: The irrigation system of Item 1, wherein the base unit is detachable from at least one of the irrigation tank, the infill pipe and a cap.

Item 9: The irrigation system of Item 1, wherein at least one power consuming device is configured to be detachably coupled to the base unit.

Item 10: The irrigation system of Item 1, wherein at least one of a plant nutrient and a plant health substance is coupled to at least a portion of an irrigation stake.

Item 11: The irrigation system of Item 10, wherein the substance coupled to the irrigation stake is configured to be activated by at least one of time release and making contact with the irrigation fluid.

Item 12: The irrigation system of Item 1, wherein an irrigation stake pipe is configured to be detachable in the proximity of the pipe entry to the irrigation stake.

Item 13: The irrigation system of Item 1, wherein a wick originating from inside the irrigation tank extends upwardly above the irrigation fluid level in the irrigation tank and terminates inside a section of a coupled irrigation stake.

Item 14: The irrigation system of Item 1, wherein the irrigation tank is configured to be embedded below the surface of the soil/bedding material and wherein an air breather coupled to the irrigation tank infill pipe equalizes air pressure inside the irrigation tank.

Item 15: The irrigation system of Item 1, wherein the system comprises a plurality of coupled irrigation tanks, and where the coupled tanks are configured to receive irrigation fluid through at least one jumper pipe.

Item 16: The irrigation system according to Item 1, wherein the irrigation system is configured to be used in indoors and outdoors environments.

Item 17: Use of an irrigation system according to Item 1 in a planter, a greenhouse or in open ground cultivation.

Control methods and systems described herein may be implemented using computer programming or engineering techniques including computer software, firmware, hardware or any combination or subset thereof.

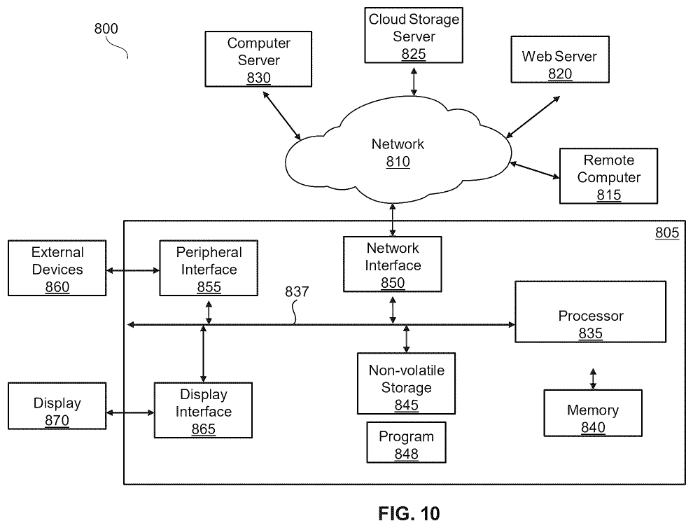

FIG. 10 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 10 is a functional block diagram illustrating a networked system 800 of one or more networked computers and servers. In an embodiment, the hardware and software environment illustrated in FIG. 10 may provide an exemplary platform for implementation of the software and/or methods according to the present disclosure.

Referring to FIG. 10, a networked system 800 may include, but is not limited to, computer 805, network 810, remote computer 815, web server 820, cloud storage server 825 and computer server 830. In some embodiments, multiple instances of one or more of the functional blocks illustrated in FIG. 10 may be employed.

Additional detail of computer 805 is shown in FIG. 10. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Circuitry as used in the present application can be defined as one or more of the following: an electronic component (such as a semiconductor device), multiple electronic components that are directly connected to one another or interconnected via electronic communications, a computer, a network of computer devices, a remote computer, a web server, a cloud storage server, a computer server. For example, each of the one or more of the computer, the remote computer, the web server, the cloud storage server, and the computer server can be encompassed by or may include the circuitry as a component(s) thereof. In some embodiments, multiple instances of one or more of these components may be employed, wherein each of the multiple instances of the one or more of these components are also encompassed by or include circuitry. In some embodiments, the circuitry represented by the networked system may include a serverless computing system corresponding to a virtualized set of hardware resources. The circuitry represented by the computer may be a personal computer (PC), a desktop computer, a laptop computer, a tablet computer, a netbook computer, a personal digital assistant (PDA), a smart phone, or any other programmable electronic device capable of communicating with other devices on the network. The circuitry may be a general purpose computer, special purpose computer, or other programmable apparatus as described herein that includes one or more processors. Each processor may be one or more single or multi-chip microprocessors. Processors are considered processing circuitry or circuitry as they include transistors and other circuitry therein. The circuitry may implement the systems and methods described in this disclosure based on computer-readable program instructions provided to the one or more processors (and/or one or more cores within a processor) of one or more of the general purpose computer, special purpose computer, or other programmable apparatus described herein to produce a machine, such that the instructions, which execute via the one or more processors of the programmable apparatus that is encompassed by or includes the circuitry, create a system for implementing the functions specified in the flow diagrams and block diagrams in the present disclosure. Alternatively, the circuitry may be a preprogrammed structure, such as a programmable logic device, application specific integrated circuit, or the like, and is/are considered circuitry regardless if used in isolation or in combination with other circuitry that is programmable, or preprogrammed.

Obviously, numerous modifications and variations of the present disclosure are possible in light of the above teachings. It is therefore to be understood that within the scope of the appended claims, the disclosure may be practiced otherwise than as specifically described herein.

Element List

101. Tank, Master Tank
102. Slave Tank
103. Cap
104. Pipe Nipple
105. Air Breather
106. Fluid Infill Opening
107. Additive Basket
108. Fluid
109. Weight
110. Wick
111. Coupler
112. Tank Extender
113. Planter/Pot
114. Bedding Material
115. Plant
116. Fluid Jumper Pipe
117. Air Equalizing Pipe
118. Extender Pipe
119. Stake Tip
120. Fluid Outlet Opening
121. Tank's Side Wall
122. Tree
123. Flower/Shrub
124. Valve
125. Tank's Top Section
126. Tank's Bottom Section
127. O-ring/Gasket
128. Direct Irrigation Stake
129. Piped irrigation Stake
130. Stake Pipe
131. Power Source
132. Processor
133. Communication Device
134. Photovoltaic Panel
135. Audio Device
136. Visual Indicator
137. Code
138. Stake Structure
139. Root Base
140. Fluid Depth Gauge/Sensor
141. Ledge/Protrusion
142. Filter
143. Additive Capsule
144. Hanging Bar/Rod/Cord
145. Hanging Ring
146. Perforated Basket Wall
147. Basket Cover
148. Cap Device Cover
149. Outlet Module Coupler
150. Flow Outlet Module
151. Light Sources
152. Nipple Cover
153. Alignment Notch
154. Ring Protrusion
155. Top Surface
156. Infill Pipe
157. Nipple (Infill Pipe)
158. Top Wall
159. Float Valve Leader
160. Openings (Irrigation Pipe)
161. Draining Hole
162. Plug
163. Base Unit Retainer
165. Base Unit
167. Power Storage/Supply
168. Antenna
169. Top of Grade
170. Fluid Conveyance Pipe
171. Direct Stake Base
172. Direct Stake Mount
173. Stake Rib Stiffener
174. Wick Channel
175. Direct Stake Top Surface
176. Nutrient
177. Anti- Virus-Bacteria-Pest
178. Anti-root Barrier
179. Stake Rib
180. Irrigation Tank Assembly
181. Short/Medium Stake (S/M)
182. Stake Pipe Entry
183. S/M Stake Top Surface
184. S/M Piped Stake Base
185. S/M Piped Stake Rib
186. S/M Piped Stake Stiffener
187. S/M Piped Stake Tip
188. Wick Channel
189. Anti-root Barrier
190. Long Piped Assembly (L)
191. L Piped Stake Top Surface
192. L Piped Stake Tip
193. L Piped Stake Rib
194. L Piped Stake Stiffener
195. L Piped Stake Leader
196. L Stake Wick Channel
197. L Stake Pipe Opening
198. Anti-root Barrier
199. Anti- Virus-Bacteria-Pest
203. Cap
205. Air Breather
208. Fluid
211. Coupler
214. Soil/Bedding Material
224. Valve
227. Gasket/O-ring
232. Processor
233. Communication Device
234. Photovoltaic Panel
240. Sensor
256. Infill Pipe
263. Base Unit Retainer
264. Remote Power Source
265. Base Unit
266. Power Entry Port
267. Power Storage/ Supply
268. Antenna
269. Top of Grade
270. Fluid Conveyance Pipe

1. An irrigation system comprising:
an irrigation tank sized to hold a volume of irrigation fluid, the irrigation tank including an infill pipe extending upwardly relative to the irrigation tank;
a base unit coupled to the infill pipe;
an external fluid conveyance pipe coupled to the infill pipe via the base unit, the external fluid conveyance pipe configured to convey pressurized irrigation fluid to the irrigation tank;
a valve assembly disposed within the base unit, the valve assembly including a valve and a float, wherein the float rises with a level of irrigation fluid entering the irrigation tank and, upon reaching a threshold level, actuates the valve to stop a flow of the pressurized irrigation fluid from the external fluid conveyance pipe into the irrigation tank; and
a plurality of irrigation stakes fluidly coupled to the irrigation tank and configured to be embedded in soil or bedding material at a depth to correspond to a depth of a root base of a plant to be grown in the soil or bedding material, wherein
the irrigation system is configured to convey the irrigation fluid from the irrigation tank to the plurality of irrigation stakes via capillary action, emitting sides of the plurality of irrigation stakes are substantially vertically aligned with the plant root base, and
the plurality of irrigation stakes are configured to dispense the irrigation fluid in response to a diminishing moisture content in the soil or bedding material.

2. The irrigation system of claim 1, further comprising a wick to convey the irrigation fluid from the irrigation tank to the plurality of irrigation stakes, wherein at least a section of the wick comprises a covering including at least one of a perforated lining comprising copper oxide, or a wicking fabric.

3. The irrigation system of claim 2, wherein the wick originates from an interior of the irrigation tank, extends upwardly above the level of the irrigation fluid in the irrigation tank, and terminates inside a section of a respective one of the plurality of irrigation stakes.

4. The irrigation system of claim 1, wherein the irrigation tank is enclosed and embeddable below a surface of the soil or bedding material, and wherein the system further comprises an air breather coupled to the infill pipe to equalize air pressure inside the irrigation tank.

5. The irrigation system of claim 1, further comprising at least one additional irrigation tank fluidly coupled to the irrigation tank via at least one jumper pipe.

6. The irrigation system of claim 1, wherein the base unit is couplable to at least one of the infill pipe and a cap disposed on the infill pipe.

7. The irrigation system of claim 1, wherein the base unit is detachably coupled to the infill pipe.

8. The irrigation system of claim 1, further comprising at least one of a plant nutrient substance or a plant health substance coupled to at least a portion of the plurality of irrigation stakes.

9. The irrigation system of claim 8, wherein the plant nutrient substance or plant health substance is configured to release upon at least one of a time delay or to remain in contact with the irrigation fluid.

10. The irrigation system of claim 1, further comprising an irrigation stake pipe that connects the irrigation tank to one of the plurality of irrigation stakes, wherein the irrigation stake pipe is detachably coupled to the one of the plurality of irrigation stakes at a pipe entry.

11. The irrigation system of claim 1, wherein the irrigation tank includes a fluid evacuation plug.

12. The irrigation system of claim 1, wherein the infill pipe defines an egress path configured to allow irrigation fluid to exit the irrigation tank through the infill pipe in the event of a failure of the valve assembly.

13. A method of irrigation utilizing the irrigation system of claim 1, the method comprising:
installing the irrigation system in one of a planter, a greenhouse, or an open ground cultivation area;
supplying pressurized irrigation fluid to the external fluid conveyance pipe; and
allowing the irrigation fluid to transfer from the irrigation tank to the soil or bedding material via the plurality of irrigation stakes by capillary action.

14. An automated irrigation system comprising:
an irrigation tank sized to store irrigation fluid;
an external pipe to convey pressurized irrigation fluid to the irrigation tank;
a base unit coupled to the irrigation tank and including an electronic valve configured to control a flow of the pressurized irrigation fluid from the external pipe into the irrigation tank;
a sensor configured to monitor a fluid level within the irrigation tank;
processor circuitry communicatively coupled to the electronic valve and the sensor;
a power source to power the processor circuitry, the sensor, and the electronic valve; and
a plurality of irrigation stakes fluidly coupled to the irrigation tank configured to convey the irrigation fluid to a plant root base via capillary action, wherein
the processor circuitry is configured to execute computer code stored in memory such that, when executed, the processor circuitry is configured to control the electronic valve to open in response to an indication from the sensor that the fluid level has fallen below a threshold level.

15. The automated irrigation system of claim 14, further comprising a wireless communication device coupled to the processor circuitry, wherein the processor circuitry is configured to transmit an alert message to a remote client via the wireless communication device in response to an indication the sensor has detected an anomaly selected from the group consisting of: fluid overflowing, extreme irrigation fluid temperature, and an excessive rate of fluid depletion.

16. The automated irrigation system of claim 14, wherein the power source comprises at least one of a photovoltaic panel and a wind turbine located locally at the base unit.

17. An irrigation stake for use with a capillary action irrigation system, the irrigation stake comprising:
an elongated body having a top end, a bottom end, and an internal channel;
a wick disposed within the internal channel, the wick configured to transport irrigation fluid via capillary action; and
a plant health substance physically coupled to the elongated body, wherein
the elongated body comprises a fluid entry point configured to receive irrigation fluid from a source tank and at least one dispensing opening configured to emit the irrigation fluid into a surrounding soil or bedding material.

18. The irrigation stake of claim 17, wherein the wick is at least partially covered by an anti-root barrier comprising a copper oxide membrane.

19. The irrigation stake of claim 17, wherein the elongated body further comprises a plurality of external ribs extending longitudinally along the elongated body, and a stake base configured to directly mount to a top surface of the source tank.

20. The irrigation stake of claim 17, wherein the plant health substance is provided in a solid or quasi-solid form and is configured to release active ingredients via time-release activation or upon contact with the irrigation fluid.
